(19) United States
(12) Patent Application Publication
(10) Pub. No.: US 2022/0331877 A1
(43) Pub. Date: Oct. 20, 2022

(54) ADDITIVE MANUFACTURING OF MONOLITHIC PRODUCTS THAT INCLUDE BRIDGE STRUCTURES

(71) Applicant: Siemens Industry Software Inc., Plano, TX (US)

(72) Inventors: James Maynard, Chino Hills, CA (US); Timothy R. Fithian, Commerce Township, MI (US); Jeffrey A. Jaje, Macomb Township, MI (US)

(21) Appl. No.: 17/632,953

(22) PCT Filed: Sep. 6, 2019
(86) PCT No.: PCT/US2019/049919

§ 371 Date: Feb. 4, 2022

(51) Int. Cl. B22F 10/85; G05B 19/4099; B33Y 50/02

(52) U.S. Cl. CPC B22F 10/85; G05B 19/4099; B33Y 50/02; G05B 2219/35134

(57) ABSTRACT

Methods for computer-aided design, engineering, visualization, or manufacturing (CAx) operations and corresponding systems and computer-readable mediums are disclosed herein. A method includes receiving, by a data processing system, a computer-aided design, engineering, visualization, or manufacturing model of a product to be manufactured. The CAx model comprises a bridge structure and at least two leg structures. The method includes slicing the CAx model into a plurality of layers, wherein each layer in each leg structure has a corresponding layer number in a sequence of layer numbers for that leg structure. The method includes maintaining an association between corresponding layer numbers of each of the leg structures. The method includes manufacturing the product according to the sequence of layer numbers and the associations, including manufacturing at least one layer of each leg structure in turn. Each leg structure completes manufacture at substantially the same time.

### TECHNICAL FIELD

The present disclosure is related, in general, to computer-aided design, engineering, visualization, and manufacturing systems (“CAD systems” or “CAx systems”), product lifecycle management (“PLM”) systems, and similar systems, that manage data for products and other items (collectively, “Product Data Management” systems or PDM systems), and to hybrid manufacturing systems and methods.

### BACKGROUND OF THE DISCLOSURE

Traditionally, machine manufacturing systems have concentrated on subtractive manufacturing (SM), where a “blank” or other workpiece is machined to remove portions, such as by milling, drilling, etc., to shape the workpiece. More recently, additive manufacturing (AM) systems such as 3D printing have been developed, which build the workpiece by adding material in the desired shapes, plus any required additional portions such as support structures. AM systems have difficulties with specific structures, complicating the manufacturing process. Improved systems are desirable.

### SUMMARY OF THE DISCLOSURE

Various disclosed embodiments include methods for computer-aided design, engineering, visualization, or manufacturing (CAx) operations and corresponding systems and computer-readable mediums are disclosed herein. A method includes receiving, by a data processing system, a computer-aided design, engineering, visualization, or manufacturing (CAx) model of a product to be manufactured. The CAx model comprises a bridge structure and at least two leg structures. The method includes slicing the CAx model into a plurality of layers, where each layer in each leg structure has a corresponding layer number in a sequence of layer numbers for that leg structure. The method includes maintaining an association between corresponding layer numbers of each of the leg structures. The method includes manufacturing the product according to the sequence of layer numbers and the associations, including manufacturing at least one layer of each leg structure in turn. Each leg structure completes manufacture at substantially the same time.

In various embodiments, multiple layers of each leg structure are each manufactured in turn. In various embodiments, the sequence of layer numbers comprises separate sequences of layer numbers for the bridge structure and each leg structure. In various embodiments, the leg structures and bridge structure are manufactured as a monolithic product so that the leg structures and bridge structure are integral and require no later attachment. In various embodiments, at least one leg structure comprises a layer with no corresponding layer in another leg structure. Various embodiments also include renumbering the sequence of layer numbers for at least one leg structure. In various embodiments, renumbering the sequence of layer numbers for at least one leg structure comprises renumbering the sequence of layer numbers from a top down starting with a top-layer number defined by a longest of the at least two leg structures.

Various disclosed embodiments also include a data processing system including a processor. The data processing system also includes an accessible memory. The data processing system is particularly configured to perform processes as described herein.

Various disclosed embodiments further include a non-transitory computer-readable medium encoded with executable instructions that, when executed, cause one or more data processing systems to perform processes as described herein.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an arbitrarily-shaped product in accordance with disclosed embodiments;

FIGS. 2 and 3 illustrate CAx models in accordance with disclosed embodiments;

FIG. 4 illustrates a flowchart of a process in accordance with disclosed embodiments; and

FIG. 5 illustrates a block diagram of a data processing system in which an embodiment can be implemented.

### DETAILED DESCRIPTION

The figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

As manufacturing tools continue to become increasingly sophisticated, additive manufacturing is increasingly attractive as an efficient and cost-effective approach for building products. Some products, however, are difficult to manufacture using conventional AM techniques. One such case is that of a product in which two or more components are joined together at their top levels by an additional component. For example, consider a table with multiple legs—if such a table were manufactured from legs up in an AM process, each leg must be manufactured separately and the tabletop which “bridges” between the legs is manufactured last. In conventional processes, it is difficult or impossible to do so in such a way that the table could be manufactured as a monolithic piece, rather than manufacturing the legs and tabletop separately and then fastening them together.

Disclosed embodiments include techniques for using AM processes to accurately build monolithic products that include separate components joined by a connecting “bridge” piece. Disclosed embodiments enable such products to be built in such a way that the separate components complete the AM process at or near the same time so that the connecting piece can built correctly and integrated as one piece with the “separate” components. For consistent reference herein, the separate vertical-feature portions of the product will be referred to as “legs” and the connecting portion of the product will be referred to as the “bridge,” though these terms are not intended to suggest other structural limitations. For example, the use of these terms is not intended to imply that the bridge must be supported on the legs in a final product. Further, while the specific examples used herein will be described in terms of a single bridge with two legs, those of skill in the art will understand that any given product manufactured as described herein may have any number of bridge structures and any number of legs.

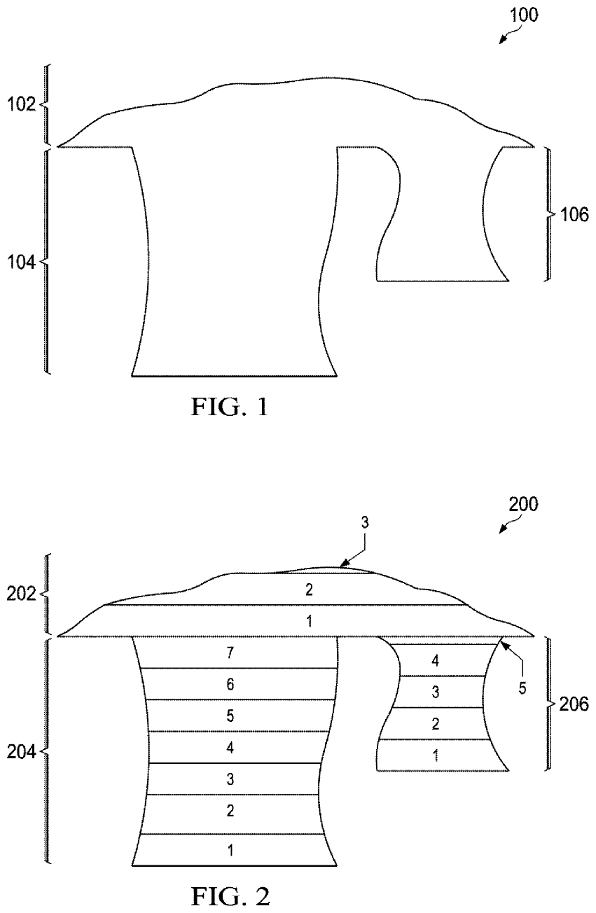

FIG. 1 illustrates an arbitrarily-shaped product 100. Product 100, in this example, is a monolithic product that has a bridge 102 that connects between a longer first leg 104 and a shorter second leg 106. In a typical AM process, it can be difficult or impossible to effectively manufacture both legs and the bridge as an integral part, requiring them to instead be manufactured separately and then joined, welded, or otherwise attached together.

FIG. 2 illustrates a CAx model 200 corresponding to product 100. In this example, CAx model 200 is a 3D solid model of the product, usable for designing and manufacturing the product itself.

In a process as disclosed herein, a CAx data processing system first “slices” the CAx model 200 into AM layers, from bottom to top. The bridge and the legs would be treated as separate components to be later joined. Note that the thickness of each “slice” generally corresponds to and is constrained by the AM process itself—a slice can be defined only as thick as the AM process can actually produce a layer during manufacture, so that a defined slice can include portions that are less than the maximum layer thickness, but cannot include portions that are more than the maximum layer thickness or the manufacture will be unsuccessful.

As illustrated in FIG. 2, the slices in the bridge 202, the first leg 204, and the second leg 206 are independently numbered, where the slice numbering indicates the order in which the layers are manufactured. While most layers are of a standard thickness, generally the maximum layer thickness, others are thinner where the full layer thickness is not needed, such as layer 5 of second leg 206, portions of layers 1 and 2 of bridge 202, and all of layer 3 of bridge 202. Note also that the adjacent layers of the legs do not actually match up at layer boundaries—that is, for example, the upper and lower boundaries (layer transitions) of layers 4-7 of first leg 204 are not at the same level as layers 1-4 of second leg 206. There need not be a one-to-one correspondence between corresponding layers of different legs. Where one leg is longer than the other(s), the number of layers in the longest leg is considered the greatest number of layers in this process or the “top-layer number.” That is, where there are multiple legs and each of them has been sliced into multiple layers, one or more of them may have a number of layers that is greater than the number of layers in other legs. The greatest number of layers is referred to herein as the “top-layer number” and is used in the renumbering process described herein.

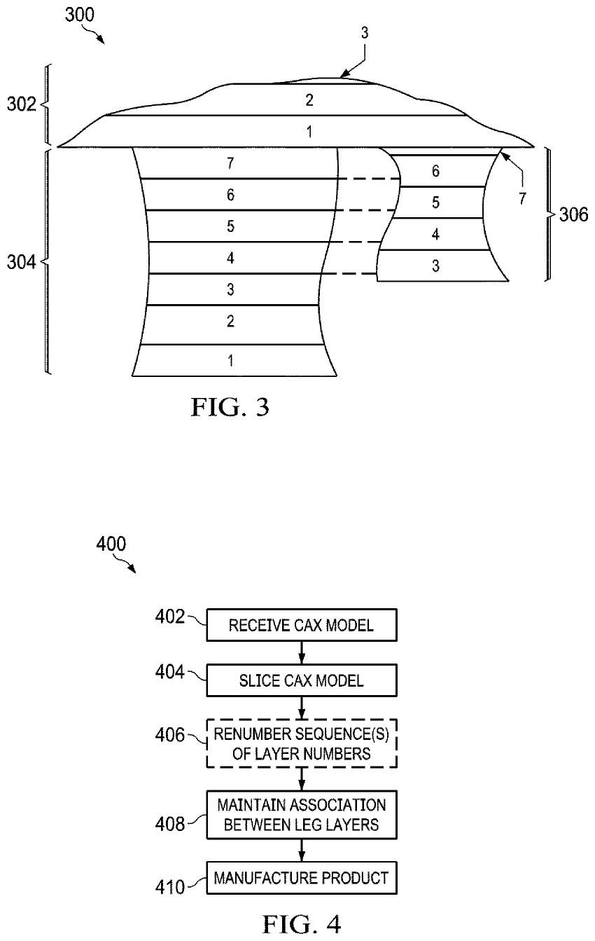

The system can then renumber the layers of each of the legs from the “top”—where the legs meet the bridge—down, starting with the top-layer number. FIG. 3 illustrates CAx model 300 corresponding to product 100, with the layers renumbered, from top to bottom, starting at the top-layer number 7, in this example. In this example, layers 1, 2, and 3 are only used to manufacture longer leg 304, and shorter leg 306 only begins its manufacture, with layer 3 of leg 306 when layer 3 is almost complete.

Dashed lines in this figure, extending from the layer boundaries of leg 304, illustrate that the layer boundaries need not be aligned between the legs. The system can maintain an association between the layers of each leg. In this example, the system can associate layer 3 of leg 304 with a portion of layer 3 of leg 306, associate layer 4 of leg 304 with a portion of layer 3 and a portion of layer 4 of leg 306, etc. In other cases, the layers need not be renumbered, as the system can maintain associations between layers regardless of the “number” assigned to that particular layer/slice. Note that the lower boundary of each layer can dictate when that layer is manufactured as relative to layers in other legs.

The system can then manufacture the product by alternating between different legs for depositing or otherwise manufacturing each layer, to ensure that each leg completes at substantially the same time. For example, in FIG. 3, the system would manufacture layers 1-3 of leg 304 first, then layer 3 (as renumbered in FIG. 3) of leg 306, then layer 4 of leg 304, then layer 4 of leg 306, etc., until the legs are completed with layer 7 of leg 304 then layer 7 of leg 306. While this example is two alternating legs, for products with multiple legs, the system can manufacture them in a round-robin or other order so that each leg has a layer added in turn as they are being manufactured.

Since each leg is manufactured at the same time, with layers added to each leg in turn, the manufacturing process reaches the bridge 302 at the top of each leg at substantially the same time, taking into account the time it takes to manufacture the final layer on each leg in turn. Stated differently, each leg 304 and 306 completes its manufacture at substantially the same time before the AM process proceeds to the bridge 302, enabling the system to efficiently create a monolithic product with a bridge and multiple legs.

That is, in this example, the system would manufacture, in order, using indentations to show the alternating between legs:
Leg 304, layer 1;
Leg 304, layer 2;
Leg 304, layer 3;
   Leg 306, layer 3 (starting that the appropriate height with respect to layer 3 of leg 304);
Leg 304, layer 4;
   Leg 306, layer 4;
Leg 304, layer 5;
   Leg 306, layer 5;
Leg 304, layer 6;
   Leg 306, layer 6;
Leg 304, layer 7;
   Leg 306, layer 7;
Bridge 302, layer 1;
Bridge 302, layer 2; and finally
Bridge 302, layer 3.

While, in this example, the transition from layer 7 of leg 304 to layer 1 of bridge 302 is made at the leg-to-bridge transition, this need not be the case in other examples. A layer can partially include a leg(s) and then include the transition to the bridge.

Building the component as one monolithic build allows for more a more complete build process and higher accuracy in simulation stages, including finite element analysis (FEA) simulations. Building it as one piece, versus welding pieces together, allows for higher accuracy of the initial design.

In a process as illustrated and described herein, the system maintains an association between the corresponding (by height) layers of the legs and designates that corresponding layers should be manufactured in turn.

In various embodiments, the system can maintain the numbering of the layers of the legs separately, as above, and track the corresponding layers of the legs, or it can “merge” the corresponding layers of the legs into a single logical layer, particularly where the layers align. That is, for example, instead of maintaining leg 304, layer 4 and leg 306, layer 4 as separate corresponding layers, the system can merge them into a single logical layer as a “merged layer 4.”

Again, while these processes have been illustrated with two legs and a bridge, they can be applied to products with any number of bridge features and any number of leg features.

FIG. 4 illustrates a flowchart of a process 400 in accordance with disclosed embodiments. Such a process may be performed, in whole or in part, by one or more data processing systems in combination with manufacturing equipment, referred to generically as the “system” below. The manufacturing equipment can include additive-manufacturing equipment such as 3D printing devices, sensors, imagers, systems, and other AM tools, materials, and machines, and can include subtractive manufacturing equipment such as mills, drills, or other SM tools, materials, and machines, and can include other devices or hardware described herein. While SM techniques are not necessarily part of the processes described herein, SM techniques can be combined with these processes in the manufacture of the product.

The system receives a computer-aided design, engineering, visualization, or manufacturing (CAx) model of a part to be manufactured (402). The CAx model has at least one bridge structure and at least two leg structures. The CAx model can be a three-dimensional (3D) solid model. “Receiving,” as used herein, can include loading from storage, receiving from another device or process, receiving via an interaction with a user, or otherwise. The part can be a metal part or a part of other materials.

The system slices the CAx model into a plurality of layers to be manufactured using an additive manufacturing (AM) process (404). The slices can be ordered in manufacturing order, such as from bottom to top (that is, for example, starting at the end of each leg structure for the leg structures, and at the leg-bridge juncture for the bridge structure). The AM process can be any AM process, including vat photopolymerization, material jetting, binder jetting, material extrusion, powder bed fusion, sheet lamination, directed energy deposition, some hybrid of these, or otherwise. Each layer has a corresponding layer number in a sequence of layer numbers, and the sequence of layer numbers can be continuous throughout the bridge structure and the leg structures or can be separate sequences of layer numbers for the bridge structure and each leg structure. Each layer in each leg structure has a corresponding layer number in a sequence of layer numbers for that leg structure.

The system can renumber the sequence(s) of layer numbers for at least one leg structure (406). As described above, this can include renumbering the sequence of layer numbers from the top down starting with the top-layer number defined by the longest of the legs, so that all of the legs have the same layer number at the top layer that abuts the bridge and then the sequence of layer numbers in each leg counts down from the top-layer number.

The system maintains an association between the corresponding layer numbers of each of the leg structures (408). This can include maintaining the association between the different corresponding layer numbers of each leg structure, where one leg structure may not have a corresponding layer number as the other, because they are of different lengths and number of layers. This can also include merging corresponding layers into a single logical layer as described herein. A “corresponding” layer number refers to the numbers of layers that are partially or wholly at the same manufacturing height. The corresponding layer numbers can be the same numbers—e.g., layer 3 of leg 304 and layer 3 of leg 306 in the example of FIG. 3—or can be different numbers, particularly if no renumbering has been performed.

The system manufactures the product according to the sequence of layer numbers and the associations, including manufacturing a layer of each leg structure in turn (410). Manufacturing each leg structure in turn need only occur for part of the manufacturing process—as illustrated in the example of layers 1 and 2 of FIG. 3, a portion of one of the legs (the longest leg) may be manufactured before the multiple legs are manufactured in turn, layer by layer. Manufacturing “a layer” of each leg structure in turn reflects that, for multiple leg structures, there must be at least one layer of one leg structure associated with and corresponding to at least one layer of another leg structure, but typically this will be true for multiple layers of each of the leg structures, and these are manufactured in turn. One of the legs—the longest leg—may have one or more layers with no corresponding layer in another leg structure.

Manufacturing a layer of each leg structure in turn ensures that the leg structures complete manufacture at substantially the same time before the bridge structure is manufactured. Substantially the same time refers to completion as one process before starting a bridge structure layer, though necessarily one of the leg structures will be completed an insignificant time before the final layer of another leg structure is completed in turn. The leg structures and bridge structure are manufactured using an AM process as a monolithic product so that the leg structures and bridge structures are integral and require no later attachment.

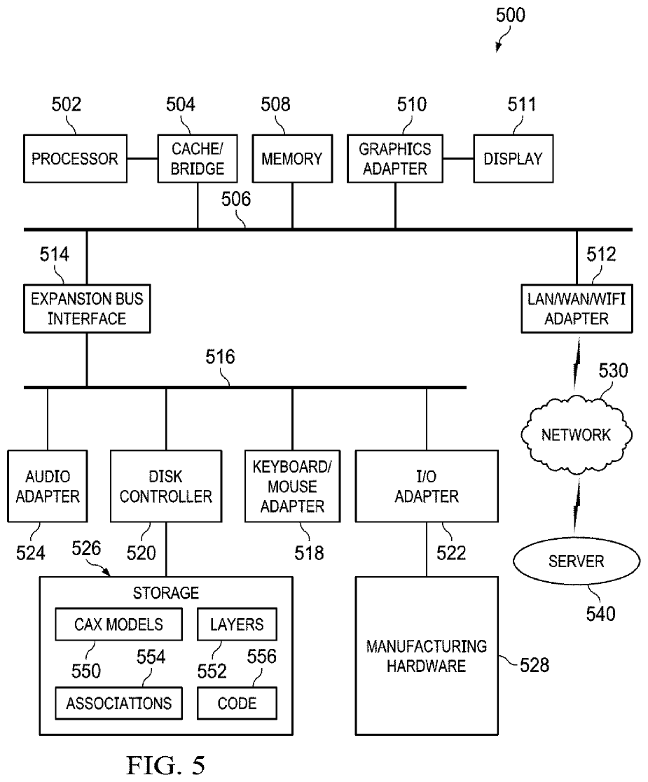

FIG. 5 illustrates a block diagram of a data processing system 500 in which an embodiment can be implemented, for example as part of a system as described herein, or as a control system as described herein, particularly configured by software or otherwise to perform the processes as described herein, and in particular as each one of a plurality of interconnected and communicating systems as described herein. The data processing system depicted includes a processor 502 connected to a level two cache/bridge 504, which is connected in turn to a local system bus 506. Local system bus 506 may be, for example, a peripheral component interconnect (PCI) architecture bus. Also connected to local system bus in the depicted example are a main memory 508 and a graphics adapter 510. The graphics adapter 510 may be connected to display 511.

Data processing system 500 and connected devices can be configured to perform any CAx processes as described herein.

Other peripherals, such as local area network (LAN)/Wide Area Network/Wireless (e.g. WiFi) adapter 512, may also be connected to local system bus 506. Expansion bus interface 514 connects local system bus 506 to input/output (I/O) bus 516. I/O bus 516 is connected to keyboard/mouse adapter 518, disk controller 520, and I/O adapter 522. Disk controller 520 can be connected to a storage 526, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Storage 526 can store any data, instructions, or code useful or necessary for performing processes herein, including but not limited to CAx models 550, layers 552, associations 554, and executable code 556.

Also connected to I/O bus 516 in the example shown is audio adapter 524, to which speakers (not shown) may be connected for playing sounds. Keyboard/mouse adapter 518 provides a connection for a pointing device (not shown), such as a mouse, trackball, trackpointer, touchscreen, etc. I/O adapter 522 can be connected to communicate with or control manufacturing hardware 528, which can be a hybrid machine as described herein, and which can include additive-manufacturing equipment such as 3D printing devices, sensors, imagers, systems, and other AM tools, materials, and machines, and can include subtractive manufacturing equipment such as mills, drills, or other SM tools, materials, and machines, and can include other devices or hardware described herein.

Those of ordinary skill in the art will appreciate that the hardware depicted in FIG. 5 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 512 can be connected to a network 530 (not a part of data processing system 500), which can be any public or private data processing system network or combination of networks, as known to those of skill in the art, including the Internet. Data processing system 500 can communicate over network 530 with server system 540 (such as cloud systems), which is also not part of data processing system 500, but can be implemented, for example, as a separate data processing system 500.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 500 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle.

1. A method comprising:
receiving, by a data processing system, a computer-aided design, engineering, visualization, or manufacturing (CAx) model of a product to be manufactured, wherein the CAx model comprises a bridge structure and at least two leg structures;
slicing the CAx model into a plurality of layers, wherein each layer in each leg structure has a corresponding layer number in a sequence of layer numbers for that leg structure;
maintaining an association between corresponding layer numbers of each of the leg structures; and
manufacturing the product according to the sequence of layer numbers and the associations, including manufacturing at least one layer of each leg structure in turn, wherein each leg structure completes manufacture at substantially the same time.

2. The method of claim 1, wherein multiple layers of each leg structure are each manufactured in turn.

3. The method of claim 1, wherein the sequence of layer numbers comprises separate sequences of layer numbers for the bridge structure and each leg structure.

4. The method of claim 1, wherein the leg structures and bridge structure are manufactured as a monolithic product so that the leg structures and bridge structure are integral and require no later attachment.

5. The method of claim 1, wherein at least one leg structure comprises a layer with no corresponding layer in another leg structure.

6. The method of claim 1, further comprising renumbering the sequence of layer numbers for at least one leg structure.

7. The method of claim 6, wherein renumbering the sequence of layer numbers for at least one leg structure comprises renumbering the sequence of layer numbers from a top down starting with a top-layer number defined by a longest of the at least two leg structures.

8. A data processing system comprising:
a processor; and
an accessible memory, the data processing system particularly configured to:
receive a computer-aided design, engineering, visualization, or manufacturing (CAx) model of a product to be manufactured, wherein the CAx model comprises a bridge structure and at least two leg structures;
slice the CAx model into a plurality of layers, wherein each layer in each leg structure has a corresponding layer number in a sequence of layer numbers for that leg structure;
maintain an association between corresponding layer numbers of each of the leg structures; and
manufacture the product according to the sequence of layer numbers and the associations, including manufacturing at least one layer of each leg structure in turn, wherein each leg structure completes manufacture at substantially the same time.

9. The data processing system of claim 8, wherein multiple layers of each leg structure are each manufactured in turn.

10. The data processing system of claim 8, wherein the sequence of layer numbers comprises separate sequences of layer numbers for the bridge structure and each leg structure.

11. The data processing system of claim 8, wherein the leg structures and bridge structure are manufactured as a monolithic product so that the leg structures and bridge structure are integral and require no later attachment.

12. The data processing system of claim 8, wherein at least one leg structure comprises a layer with no corresponding layer in another leg structure.

13. The data processing system of claim 8, wherein the data processing system is further configured to renumber the sequence of layer numbers for at least one leg structure.

14. The data processing system of claim 13, wherein renumbering the sequence of layer numbers for at least one leg structure comprises renumbering the sequence of layer numbers from a top down starting with a top-layer number defined by a longest of the at least two leg structures.

15. A non-transitory computer-readable medium encoded with executable instructions that, when executed, cause one or more data processing systems to:
receive a computer-aided design, engineering, visualization, or manufacturing (CAx) model of a product to be manufactured, wherein the CAx model comprises a bridge structure and at least two leg structures;
slice the CAx model into a plurality of layers, wherein each layer in each leg structure has a corresponding layer number in a sequence of layer numbers for that leg structure;
maintain an association between corresponding layer numbers of each of the leg structures; and
manufacture the product according to the sequence of layer numbers and the associations, including manufacturing at least one layer of each leg structure in turn, wherein each leg structure completes manufacture at substantially the same time.

16. The non-transitory computer-readable medium of claim 15, wherein multiple layers of each leg structure are each manufactured in turn.

17. The non-transitory computer-readable medium of claim 15, wherein the sequence of layer numbers comprises separate sequences of layer numbers for the bridge structure and each leg structure.

18. The non-transitory computer-readable medium of claim 15, wherein the leg structures and bridge structure are manufactured as a monolithic product so that the leg structures and bridge structure are integral and require no later attachment.

19. The non-transitory computer-readable medium of claim 15, wherein at least one leg structure comprises a layer with no corresponding layer in another leg structure.

20. The non-transitory computer-readable medium of claim 15, further encoded with executable instructions to renumber the sequence of layer numbers for at least one leg structure by renumbering the sequence of layer numbers from a top down starting with a top-layer number defined by a longest of the at least two leg structures.
